(19) United States
(12) Patent Application Publication
(10) Pub. No.: US 2017/0182932 A1
(43) Pub. Date: Jun. 29, 2017

(54) COMPONENT OF TRANSPARENT FILM AND THE PRODUCTION THEREOF

(71) Applicant: GRUPO ANTOLÍN-IRAUSA, S.A., Burgos (ES)

(72) Inventors: Klaus Münker, Griesstätt (DE); Thomas Paule, Glattbach (DE); Johannes Götzelmann, Altertheim (DE)

(21) Appl. No.: 15/300,463

(22) PCT Filed: Mar. 11, 2015
(86) PCT No.: PCT/EP2015/055084

§ 371 Date: Sep. 29, 2016

(30) Foreign Application Priority Data
Mar. 31, 2014 (DE) 10 2014 206 034.6

(51) Int. Cl. B60Q 1/26; B60Q 1/30; F21S 8/10; B60Q 1/00

(52) U.S. Cl. CPC B60Q 1/2619; B60Q 1/0076; B60Q 1/30; B60Q 1/0088; F21S 48/2212; B29C 51/264

(57) ABSTRACT

The invention relates to a component for a motor vehicle, consisting of a plastic transparent film in a defined wave length range, the inner, non-visible side of the film being printed with a covering varnish by means of screen printing and partial areas are free of said covering. At least one illuminating means for illuminating is applied to the film in the region of the non-printed partial areas and the film is in-mould decorated with plastic material. The invention also relates to a method for producing the component.

The object of the invention is a component for a motor vehicle consisting of a plastic transparent film in a defined wavelength range, the inner, non-visible side of the film being printed with a covering varnish by means of screen printing.

Furthermore, a method for producing the component according to the invention is proposed.

### BACKGROUND TO THE INVENTION

In the production of interior solutions for motor vehicles, lighting is a subject that is being given increasing consideration. Different dashboard solutions provide for illuminated switches or fully concealed controls which, in the form of black panels, present a harmonious surface and only display a function when lighting from behind illuminates instrument or the switch.

Even on the exterior of the vehicle lighting elements are a consideration. For example, DE102012003200A1 shows a body part of transparent or translucent material. The material is provided with an outer coating which is at least partially translucent. To achieve this translucence the outer coating is perforated in the region of the light source, or a semi-transparent layer of varnish is formed.

The use of plastic components on the exterior of the motor vehicle provides the possibility of producing body parts of the above-mentioned type.

However, it is not only lighting elements that are consideration for the exterior of the vehicle. Further control elements, sensors or indicators also enhance the safety and user friendliness of the vehicle. The object of the invention is therefore to propose a component for use on the body of the motor vehicle which can be produced economically, which at the same time provides the possibility of a high degree of integration of functions and meets the requirement for a disappearing display effect.

The object of the invention is achieved with the features of claim 1.

The object is achieved with a component for a motor vehicle consisting of a transparent plastic film in a defined wavelength range, the inner, non-visible side of the film being printed with a covering varnish by means of screen printing, wherein partial areas are free of said covering and wherein at least one illuminating means for illumination is applied to the film in the region of the non-printed partial areas and the film is in-mould decorated with plastic material. In the solution according to the invention there is the advantage that the display is rendered visible by the illuminating means and the activated condition disappears completely. This is achieved by covering with covering with covering varnish on the back of the transparent material. Only in this manner can the disappearing effect can be achieved with high quality so that the surface in the exterior area of the vehicle appears to be uninterrupted even in varying light radiation conditions.

The invention advantageously provides for the outwardly facing side to be printed or varnished, the applied coat being at least partially transparent or transparent in the region of the non-printed partial areas. This enables the component according to the invention to be adapted to the car colour whilst rendering the means of illumination visible after activation.

To achieve a high degree of integration of functions the film is printed on directly or the circuits or electrical components are printed on the covering coat of varnish, where the circuits are not located in the unprinted partial areas. The component can be produced economically by means of screen printing and pad printing.

In order to give the component a three-dimensional configuration it is advantageous for the film to be thermally formable.

Functional components in the fields of lighting, sensorics and display indications are advantageously applied to the film.

It is particularly advantageous if the component has means of illumination in the spatial vicinity of a capacitive switch when used in the exterior area of a motor vehicle.

It has proven advantageous to fit a tailgate or boot lid of a vehicle with the inventive solution, a switch being fitted to open the tailgate, with means of illumination that can be activated when the switch is used.

The inventive method for producing a component for a motor vehicle is designed so that a film is printed by screen printing on the inside with non-printed partial areas provided with a covering coat of varnish, and so that at least one means of illumination is applied to the inside of the film in the non-printed partial area, whereupon the film is subjected to thermal forming into a three-dimensional shape and the film is in-mould decorated with a plastic material in its three-dimensional configuration.

The inventive method enables the film to be printed and/or loaded with components before or after thermal forming.

In the inventive method the film is varnished on the outside, the coat of varnish being at least partially transparent for the wavelength of the means of illumination in the region of the non-printed partial areas.

In the inventive method a region is provided for a capacitive switch or a capacitive film is used in one region.

### BRIEF DESCRIPTION OF THE INVENTION

The invention is represented in the figures and is explained in greater detail in the following description.

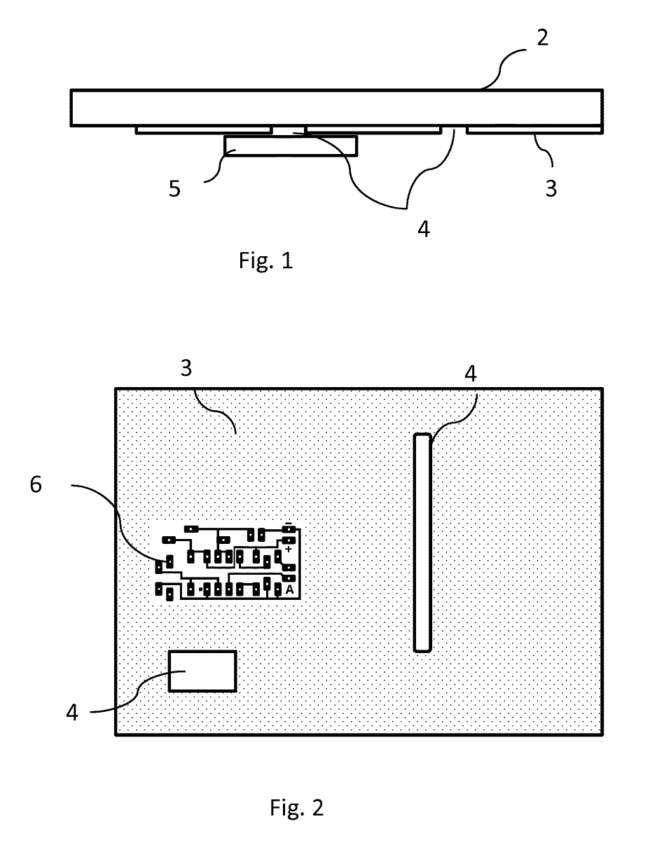

FIG. 1 shows a section through the component according to the invention.

FIG. 2 shows an elevation of the component according to the invention.

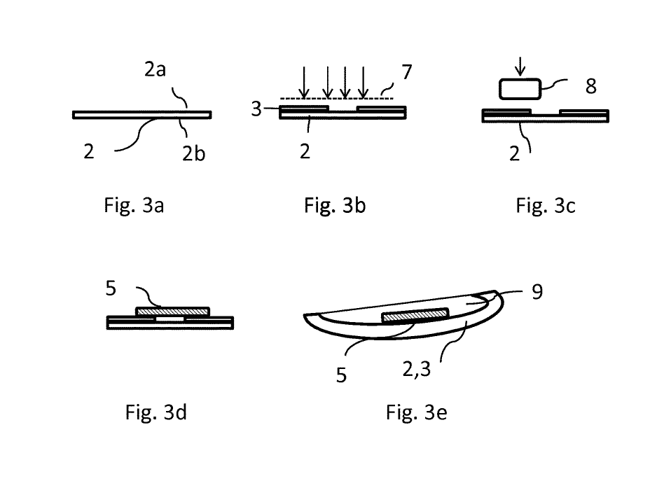

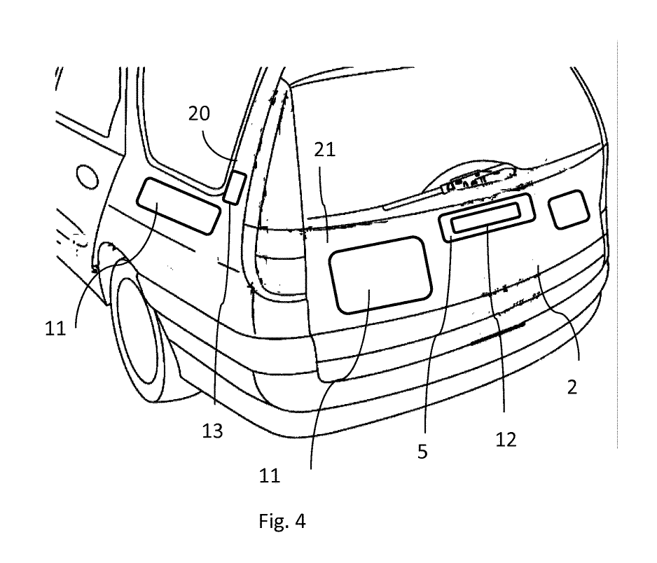

FIG. 3 shows the method steps for producing the component according to the invention.

FIG. 4 shows an elevation of the inventive solution on the vehicle.

FIG. 1 shows a section through a transparent film 2. A covering coat of varnish 3 can be seen on the inside 3 of film 2 directed towards the vehicle. This covering coat of varnish 3 has non-printed partial areas 4 in which partial areas 4 are not covered by the covering coat of varnish. An illumination means 5, which is applied to the covering coat of varnish in partial area 4, is represented diagrammatically.

FIG. 2 shows in elevation film 2 which is fully covered on the inside by a covering coat of varnish 3, partial areas 4 being recessed. No applied illumination means are shown in this view. A circuit and electrical components 6 can be seen diagrammatically. In this embodiment these circuits and electronic components 6 are applied directly to the covering coat of varnish 3.

FIG. 3 shows the method steps for producing a three-dimensional component in sequence. A transparent film 2 is provided, beginning with a. The transparent film consists of a material which is fully or partially transparent for the wavelength of the illumination means to be installed later.

In this case the material is, for example, PMMA or polycarbonate and any other transparent plastic for a desired wavelength. Here the thickness of the film is 250-800 μm. In the first method step the film is clamped tight and secured in a screen printing tool.

In the next method step the film is printed on its inside 2a in a screen printing process with a covering coat of varnish. Partial areas 4 are excluded from the printing by masking in the screen printing device 7. Here the colour of the screen printing may be freely selected and can be adapted to the optical requirements of the component.

In an additional method step, which is not shown in FIG. 3, the outer surface 2b can be provided in a screen printing process with a coat of varnish. Here all surfaces are possible, for example varnishing in the colour of the car, metal surfaces, semi-transparent surfaces and printing of the surface in a single colour, fine recesses being provided in the region of the illumination means to be subsequently installed. This ensures that the light of the illumination means is able to shine through the outer coat of varnish. Due to the screen printing and the possibility of applying even fine structures in the outer coat of varnish, additional work steps which normally have normally had to be carried out hitherto are avoided. In the state of the art the coat of varnish had to be processed by removal with a laser. This work step is omitted in screen printing.

In method step c a tool for pad printing 8 is shown diagrammatically. In this embodiment circuits and electrical components 6 are applied to the covering coat of varnish 3. However, it is also possible to apply the circuits and electrical components directly to film 2. Pad printing has been chose as an example here, but other printing processes proven in the state of the art may also be used.

Almost all components required for electronic applications are also produced in printed electronics. OFETs, OLEDs and OPVCs, as well as diodes, different types of sensors, storage elements and display systems, as well as antennae and batteries, are the points of focus of current developments. Both organic and inorganic materials are used or printed electronics. Today a wide variety of printable materials of polymers are available which display conductive, semi-conductive, electroluminescent, photovoltaic and other functional properties. Other polymers are in most cases used as insulators and dielectrics.

RFID antennae may also be used in screen printing from metal-containing ink.

Integrated circuits from OFETs, OLED displays and solar cells based on OPVCs which are produced using printing processes, as well as other printed components and modules, should be used wherever the specific properties of the printed electronics are beneficial, i.e. where simple, low cost, flexible and large-area electrical components are required.

In a simple embodiment the electrical cables for illumination means 5 are applied to the coat of varnish 3. In a further embodiment the components are printed on for a switch. A further example of an electronic component is a keypad which is represented by capacitive membrane switches.

In method step d it is shown diagrammatically that an illumination means 5 is applied to the inside of the film. Illumination means 5 is an LED or an OLED which is applied so that it shines through the non-printed partial area 4 and transparent film 2. In this method step the illumination means is secured, for example, by gluing it with an optimum adhesive directly to the transparent film or by gluing it to varnish coat 3.

However, it is also possible to apply the illumination means 5 in a subsequent method step.

The transparent film 2 is converted to a three-dimensional shape in a thermo-forming process. DE 102007004727 A1 discloses a method for thermo-forming of a film which is provided for the surface of a motor vehicle component, whereupon it is in-mould formed, decorated or backfilled.

This method step is shown in FIG. 3e. Film 2, with varnish coat 3, is thermally formed into a three-dimensional shape. It is now possible for the illumination means 5 only now to reduce the risk of destruction by the thermal forming process. Here the illumination means can be glued back onto the film, or is inserted in the thermoforming tool so that it is fixed in the correct position in the subsequent remoulding process.

The film can be remoulded with transparent material because the non-transparent varnish coat forms a visual barrier. Alternatively the transparent film can be in-mould decorated with a non-transparent plastic material so that the component can be insulated from behind against diffused light, even in the partial areas in which no varnish coat is present and where illumination means are installed.

Further functions and hence components can be integrated into this method of producing a component from transparent film. The production can be extended to the installation of further electrical or electronic components. As soon as the transparent film is provided with the covering varnish coat and is converted to the final three-dimensional shape, components can be applied to the film. For example, capacitive switches are important components here for the production of vehicle tailgate and boot lids. The capacitive switches are used to open and close the boot lid of the vehicle by contact or the mere approach of the driver. The capacitive switches are in this case printed on the film or are applied as a single component, or already form part of a special capacitive film. This special capacitive film may be used as an integral part of the actual transparent film and as a basic material for all subsequent steps.

FIG. 4 shows the rear area of a vehicle. In this example the vehicle has a tailgate 21 in which a rear windscreen and a windscreen wiper are indicated. The varnished area of the tailgate consists of an inventive component which consists of a transparent film which is printed at least on the inside with screen printing. In an embodiment provided as an example a capacitive switch 12 is arranged centrally on the tailgate 21. Capacitive switch 12 has a frame which is illuminated in this example. In the unlit condition the frame disappears completely with the inner illumination means 5. When capacitive switch 23 is activated the illumination means is activated and the frame lights up. This embodiment is only one example of possible illumination which completely disappears behind the surface when not activated. Surface displays 11, which are arranged inside the transparent film, are indicated diagrammatically in this example. These displays 11 could be used, for example, to indicate a special traffic phenomenon, for instance to represent a traffic jam warning at the rear. Firstly a further display 11 can be seen in the region of the side trim 20, together with a keypad 13. In this case keypad 13 is configured by the arrangement of small switch capacitors. Such a keypad can be used for inputting a release code for the vehicle. In this embodiment is also possible for keypad 13 to be provided with backlighting with an illumination means 5.

### REFERENCE NUMBERS

### 1 Component

### 2 Film

### 2a Interior

### 2b Exterior

3 Coat of varnish
4 Partial areas
5 Illumination means
6 Circuit and electrical components
7 Screen printing device
8 Pad printing
9 In-mould decorated plastic

### 11 Display

12 Capacitive switch

### 13 Keypad

### 20 Trim

### 21 Tailgate

1. A component for a motor vehicle, comprising a transparent film of plastic in a defined wavelength range, characterised in that the inner, non-visible side of the film is printed with a covering varnish coat by means of screen printing, wherein partial areas are free of said covering and wherein at least one illumination means is applied to the film in the region of the non-printed partial areas and the film is in-mould decorated with plastic material.

2. The component according to claim 1, wherein the outwardly facing side is printed or varnished, wherein the applied coat is at least partially transparent or transparent in the region of the inner non-printed partial areas.

3. The component according to claim 1, wherein circuits or electrical components are printed onto the film or onto the covering varnish coat, wherein the circuits or electrical components do not lie in the non-printed partial areas of the film.

4. The component according to claim 1, wherein the film is thermally formable.

5. The component according to claim 1, wherein functional components in the fields of at least one of lighting, sensorics and displays are applied to the film.

6. The component according to claim 1 wherein for use in the exterior area of a motor vehicle, the at least one illumination means is applied in the spatial vicinity of a capacitive switch.

7. The component according to claim 1, wherein the component is a tailgate or a boot lid of a vehicle, wherein a switch is fitted for opening the tailgate and at least one illumination means can be activated when the switch is used.

8. A method for producing a component for a motor vehicle, comprising a film being printed on the inside with a varnish, with non-printed partial areas, wherein at least one illumination means is applied to the inside of the film in the non-printed partial area, wherein the film is then thermally formed into a three-dimensional shape, and wherein the film is in-mould decorated with a plastic material in its three-dimensional configuration.

9. The method according to claim 8, wherein the film is loaded with components before thermal forming.

10. The method according to claim 8, wherein the film is printed with components before thermal forming.

11. The method according to claim 8, wherein the film is varnished on its outside, wherein the varnish coat is at least partially transparent for the wavelength of the illumination means in the region of the non-printed partial areas.

12. The method according to claim 8, wherein an area is provided for a capacitive switch in the film or a capacitive film is used in a particular area.

13. The method according to claim 9, wherein the film is varnished on its outside, wherein the varnish coat is at least partially transparent for the wavelength of the illumination means in the region of the non-printed partial areas.

14. The method according to claim 10, wherein the film is varnished on its outside, wherein the varnish coat is at least partially transparent for the wavelength of the illumination means in the region of the non-printed partial areas.

15. The method according to claim 9, wherein an area is provided for a capacitive switch in the film or a capacitive film is used in a particular area.

16. The method according to claim 10, wherein an area is provided for a capacitive switch in the film or a capacitive film is used in a particular area.

17. The method according to claim 11, wherein an area is provided for a capacitive switch in the film or a capacitive film is used in a particular area.

18. The component according to claim 2, wherein the film is thermally formable.

19. The component according to claim 3, wherein the film is thermally formable.

20. The component according to claim 2, wherein functional components of at least one of lighting, sensorics and displays are applied to the film.
